(19) United States
(12) Patent Application Publication
(10) Pub. No.: US 2011/0210068 A1
(43) Pub. Date: Sep. 1, 2011

(54) Water Dispensing Methods and Systems

(76) Inventors: Peggy I. Lalor, Hood River, OR (US); Douglas M. Horn, Peeples Valley, AZ (US)

(21) Appl. No.: 12/714,463

(22) Filed: Feb. 27, 2010

(51) Int. Cl. C02F 9/08; B01D 35/16

(52) U.S. Cl. 210/636; 210/202; 210/638

(57) ABSTRACT

A method includes performing at least two of the following three treatments to produce at least two types of treated water: reverse osmosis, alkalinization, and carbon filtration. The types of treated water are individually dispensed at different times from a common spout. A method includes individually cooling the types of treated water at different times in a common cold tank prior to dispensing. The common cold tank is purged prior to cooling a different type of treated water. A method includes treating water by electrolysis to produce alkaline water and acidic water and producing at least one additional type of treated water by reverse osmosis or carbon filtration. Consumer containers are rinsed with the acidic water. A system includes: a dispensing unit, a treatment unit remotely located from the dispensing unit, treated water supply lines connecting the treatment unit to the dispensing unit, and a process control unit.

### BACKGROUND OF THE INVENTION

The increased popularity of bottled water produces increased waste from the disposable plastic water bottles. Some individuals install water filtration equipment in their home to produce purified water for use in their own containers. However, such equipment can be expensive to purchase and install and time-consuming to maintain, depending on the type of filtration. Without proper maintenance, the effectiveness of purification may be compromised.

Many retail establishments provide purified water vending machines, primarily for consumers to fill bulk water containers, such as 1 to 5 gallon containers, for later dispensing at home. Most water vending machines use a combination of activated carbon filtration, reverse osmosis, and ultraviolet sterilization in series to provide the desired level of purification. Some use only carbon filtration in combination with ultraviolet sterilization. Some vending machines are coin operated while others are not. Normally, the vending machines dispense room temperature water, though a few known devices may adjust the temperature to be hot or cold. Also, normally the vending machines dispense plain water, though one known device that only uses carbon filtration includes the option of carbonating and/or flavoring filtered water.

### BRIEF DESCRIPTION OF THE DRAWINGS

Preferred embodiments of the invention are described below with reference to the following accompanying drawings.

FIGS. 1-3 are perspective, side, and front views, respectively, of a dispensing unit according to an embodiment.

FIGS. 4-6 are front views of a filtration skid, a tank skid, and the two skids combined in a treatment unit, respectively, according to an embodiment.

FIG. 7 is a simplified process flow diagram for the treatment unit in FIG. 6.

FIG. 8 is a simplified process flow diagram for the dispensing unit in FIGS. 1-3.

### DETAILED DESCRIPTION OF THE PREFERRED EMBODIMENTS

Although many options exist for dispensing purified water in a retail setting, none of the known devices present consumers with a choice of the type of purification process applied to the water. That is, individual devices merely provide purified water normally produced by a series of treatments including carbon filtration, reverse osmosis, and ultraviolet sterilization. A different device may provide purified water produced only by carbon filtration, but no known individual device provides both. No known devices offer the choice of selecting a subset of the purification processes used in the device. Known devices uniformly apply all of the purification processes available in the device to all dispensed water. Embodiments are described herein that involve dispensing at least two types of treated water from a water dispensing system.

Also, known devices for retail dispensing of purified water occupy a large footprint and are typically only available in large establishments. To address the size issue, some retailers even locate known devices outdoors. The vast majority of the known devices are designed to fill bulk containers for home use. Known devices designed to fill personal-sized consumer containers, such as 0.5 to 1 liter, are very limited in availability. Most of such devices limit purification processes to carbon filtration. No known devices are designed to fill personal-sized containers as well as bulk containers. Embodiments are described herein that involve dispensing remotely treated water, significantly reducing the size of the dispensing unit. Embodiments are also described herein that involve filling personal-sized containers as well as bulk containers.

In addition to the advantages described above, the embodiments herein may be configured to offer all the existing water options available in the plastic single-use market. Specifically, multiple types of purified water may offered as chilled or room temperature, flat or carbonated, and plain or flavored. Even so, disposable bottle waste may be reduced since consumers may use their own containers.

In an embodiment, a water dispensing method includes performing at least two of the following three treatments to produce at least two types of treated water: 1) treating water by reverse osmosis to produce RO water, 2) treating water by alkalinization to produce alkaline water, which has a pH greater than 7, and 3) treating water by filtration through carbon to produce filtered water. Without substantially commingling the at least two types the water, the method includes individually dispensing the at least two types of treated water at different times from at least one common spout into consumer containers.

Understandably, the apparatuses described herein that are suitable for performing the water dispensing method may involve some small amount of commingling resulting from residual water in supply lines, manifolds, valves, spouts, etc. Such commingling is not considered substantial in the context of the present document. Known water vending machines only provide purified water that is substantially commingled since the treatment processes occur is series and only dispense one type of purified water to consumer containers.

Known reverse osmosis treatment apparatuses may be used to produce the described RO water. Alkalinization in the context of the present document refers to any treatment that produces water with pH greater than 7. Alkaline water has been identified in public literature as possessing health benefits in comparison to acidic or neutral water with pH less than or equal to 7. Chiefly, alkalinization may be accomplished by electrolysis, but is defined herein to encompass any method, including non-electric methods, such as admixture of alkaline compounds with water. Electrolytic methods may be described as electrochemical ionization, electrolytic oxidation, electrochemical activation, etc. Some individuals believe the most significant health benefits of alkaline water are only obtained with electrolysis. The carbon used in the described filtering may be known, activated carbon suitable for purifying water.

By way of example, the treatment by alkalinization may include electrolysis that also produces acidic water as an additional type of treated water. The method may further include rinsing the consumer containers with the acidic water prior to the dispensing by using a rinsing spout separate from the at least one common spout.

The method may include performing the three treatments to produce at least three types of treated water. Without substantially commingling the at least three types of treated water, they may be individually dispensed at different times from the at least one common spout. The method may further include treating a portion of the filtered water by carbonation to produce carbonated, filtered water as an additional type of treated water. Without substantially commingling the four types of treated water, they may be individually dispensed at different times from the at least one common spout.

Accordingly, the water dispensing method may include selecting from among reverse osmosis, alkalinization, carbon filtration, and carbonation to dispense two, three, or four types of treated water at different times from the same spout. Conceivably, inclusion of additional types of treatment may allow dispensing still further types of treated water from a common spout.

A dispensing unit may include the at least one common spout and the at least two treatments may occur in a treatment unit that is remotely located and structurally independent from the dispensing unit. The method may further include supplying the at least two types of treated water from the treatment unit to the dispensing unit through at least two respective treated water supply lines.

The method may further include communicating process control signals between the dispensing unit and the treatment unit. All physical connections between the dispensing unit and the treatment unit during operation may consist of the at least two treated water supply lines and the process control signals, along with their wired or wireless carrier media. In practice, a bundle of supply lines and process control wiring, if any, may be referred to as an “umbilical cord” and constitute the sole physical connection between the dispensing unit and the treatment unit, aside from wireless process control signals, if any.

The dispensed water may be selectively cooled. For example, the method may further include, without substantial commingling, individually cooling the at least two types of treated water at different times in a common cold tank prior to the dispensing. A record may be kept of the last type of treated water cooled in the common cold tank and the method may include purging the common cold tank prior to cooling a different type of treated water. In this manner, a single cold tank may be provided in a dispensing unit and yet used for cooling each of the different types of treated water without substantial commingling.

In another embodiment, a water dispensing method includes performing at least two of the following three treatments to produce at least two types of treated water: 1) treating water by reverse osmosis to produce RO water, 2) treating water by alkalinization to produce alkaline water, and 3) treating water by filtration through carbon to produce filtered water. Without substantially commingling the at least two types of treated water, the method includes individually cooling the at least two types of treated water at different times in a common cold tank prior to dispensing from at least one spout. The dispensing occurs as a part of a retail transaction in response to a purchaser's selections input to a programmable logic controller that controls the dispensing. The programmable logic controller keeps a record of the last type of treated water cooled in the common cold tank. The method includes purging the common cold tank prior to cooling a different type of treated water.

The at least two types of treated water may be dispensed from at least one common spout or from separate spouts each designated for a particular type of treated water. Nevertheless, a common cold tank may be used. Programmable logic controllers (PLCs) are well known and widely used in process control systems. Any known controller capable of accomplishing the control schemes described herein may be used, possibly including controllers not considered to be PLCs.

By way of example, the common cold tank may be comprised by a dispensing unit and the at least two treatments may occur in a treatment unit that is remotely located and structurally independent from the dispensing unit. The method may include supplying the at least two types of treated water from the treatment unit to the dispensing unit through at least two respective treated water supply lines. The method may further include communicating process control signals between the dispensing unit and the treatment unit. All physical connections between the dispensing unit and the treatment unit during operation may consist of the at least two treated water supply lines and the process control signals, along with their wired or wireless carrier media.

In a further embodiment, a water dispensing method includes treating water by electrolysis to produce two types of treated water including alkaline water and acidic water. At least one of the following two treatments are performed to produce at least one additional type of treated water: 1) treating water by reverse osmosis to produce RO water and 2) treating water by filtration through carbon to produce filtered water. The method includes rinsing consumer containers with the acidic water from a rinsing spout. After the rinsing, the alkaline water and the at least one additional type of treated water are individually dispensed from at least one spout separate from the rinsing spout. The dispensing occurs as a part of retail transactions in response to purchasers' selections input to a programmable logic controller that controls the dispensing. The alkaline water and the at least one additional type of treated water may be dispensed from at least one common spout or from separate spouts each designated for a particular type of treated water.

By way of example, the rinsing may occur with the consumer containers in a rinsing position that is inverted with respect to a dispensing position. Accidental consumption of the acidic water used for the rinsing may be reduced by limiting rinsing to occur only with the consumer container inverted. The electrolysis and the two treatments may be performed to produce four types of treated water. A fifth type of treated water may be produced by treating a portion of the filtered water by carbonation. The method may include individually dispensing the alkaline water, the RO water, the filtered water, and the carbonated, filtered water from the at least one spout.

The rinsing spout and the at least one spout may be included in a dispensing unit. The four treatments may occur in a treatment unit that is remotely located and structurally independent from the dispensing unit. The method may additionally include supplying the five types of treated water from the treatment unit to the dispensing unit through five respective treated water supply lines. Additionally, the method may include communicating process signals between the dispensing unit in the treatment unit, wherein all physical connections between the dispensing unit and the treatment unit during operation consist of the five treated water supply lines and the process control signals, along with their wired or wireless carrier media.

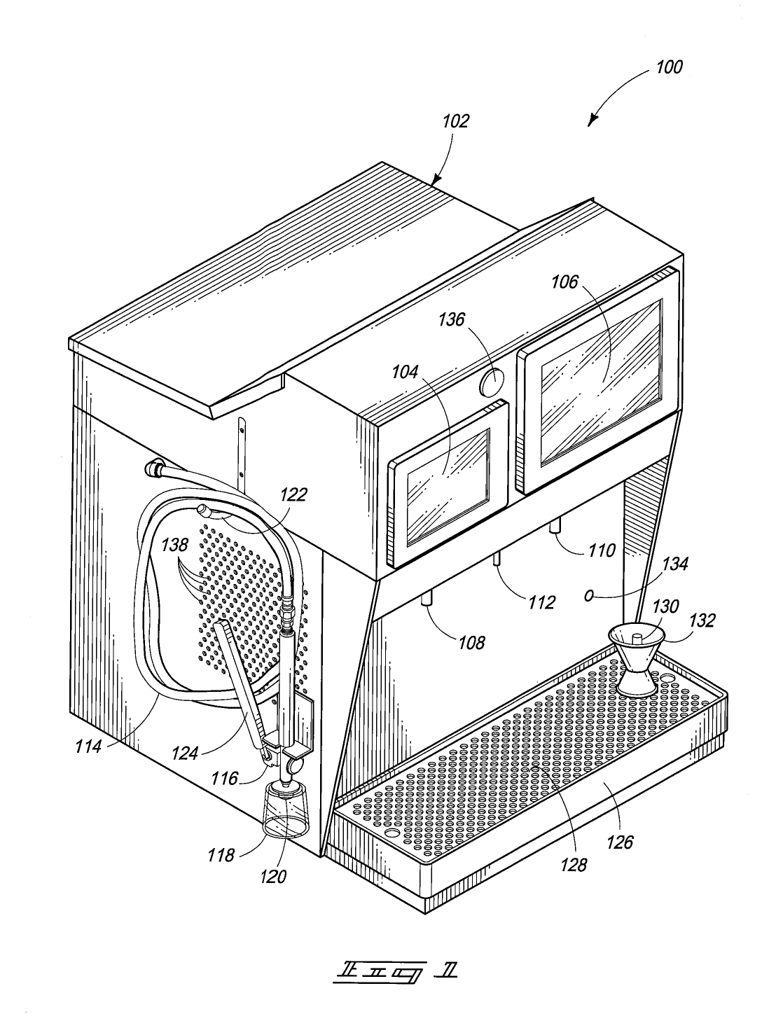

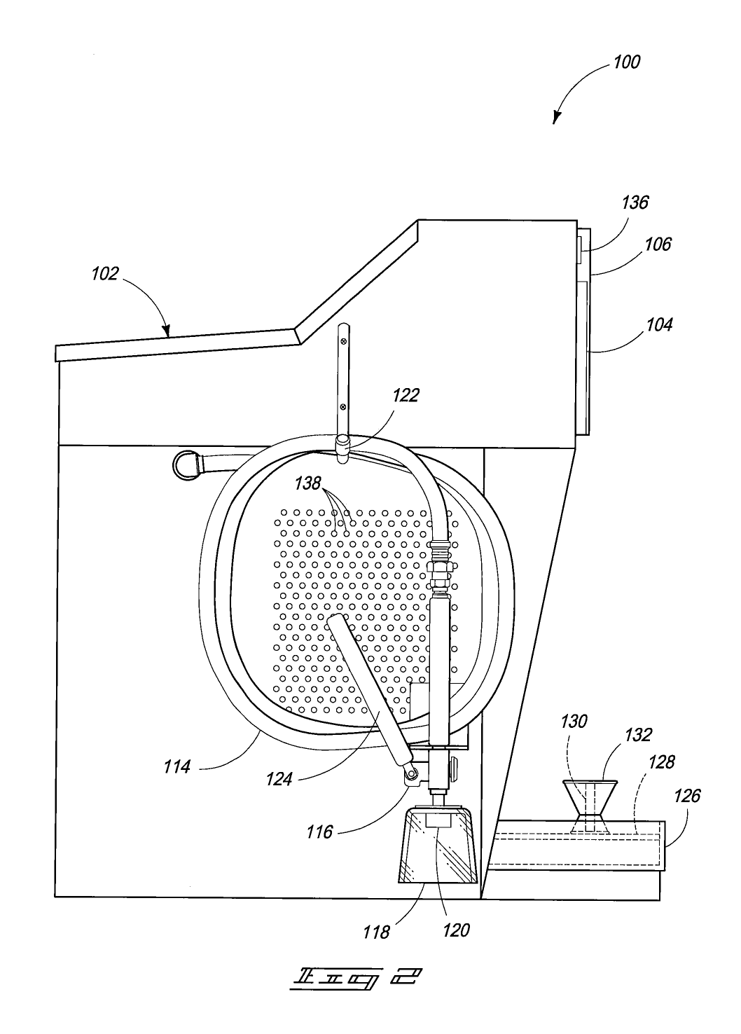

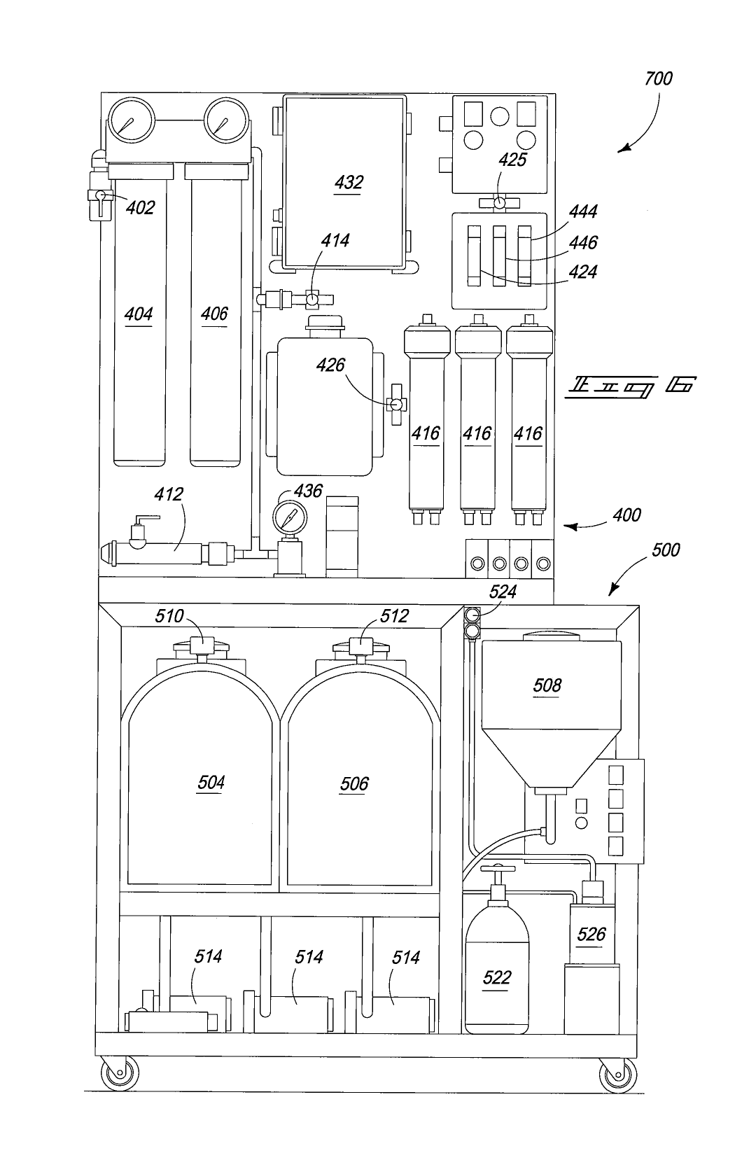

The water dispensing methods described herein may be performed in a variety of systems, apparatuses, or devices. FIGS. 1-8 show an embodiment of a water dispensing system that may be suitable for performing at least some of the described water dispensing methods. FIGS. 1-3 show perspective, side, and front views of a dispensing unit 100 contained within and on a housing 102. Dispensing unit 100 is adapted for countertop use in a position remotely located with respect to a treatment unit 700 shown in FIG. 6.

It will be appreciated that dispensing unit 100 may be particularly well-suited for use in a convenience store, coffee shop, fast food restaurant, or other retail establishment with limited customer space. An electronic touch screen 104 presents one example of an input device for purchasers to make selections. Other known devices, such as buttons, switches, a keyboard, etc., that allow input to a process control system may be used. An electronic display screen 106 allows presentation of marketing and/or product information pertaining to dispensing unit 100, as well as other advertising.

Dispensing unit 100 includes a water spout 108 and a water spout 110. Both water spouts 108, 110 may be common spouts configured to dispense multiple types of treated water at different times. Providing two spouts allows consumers to fill multiple containers more quickly.

A flavor spout 112 may be used to dispense a measure of flavoring into a container before or after filling the container with water. Multiple flavorings may be provided and may be liquid. The amount of flavoring dispensed may be solely controlled by a consumer, may be controlled by predetermined settings, or may be controlled by some combination of the two, such as allowing purchase of multiple, measured quantities. Instead of or in addition to providing flavor spout 112, flavoring may be injected into treated water prior to flowing out of water spouts 108 or 110. Injecting the flavoring immediately prior to treated water exiting water spouts 108 or 110 may reduce cross-contamination between multiple consumers' dispensed water. Injection may also limit consumer control of the flavor quantity and reduces over use. The process control system may be configured to operate a pump or other device that dispenses the flavoring either by injection or through spout 112. Flavoring may be stored in a container inside dispensing unit 100 or elsewhere that is configured to allow maintenance personnel to easily view the level of remaining flavoring.

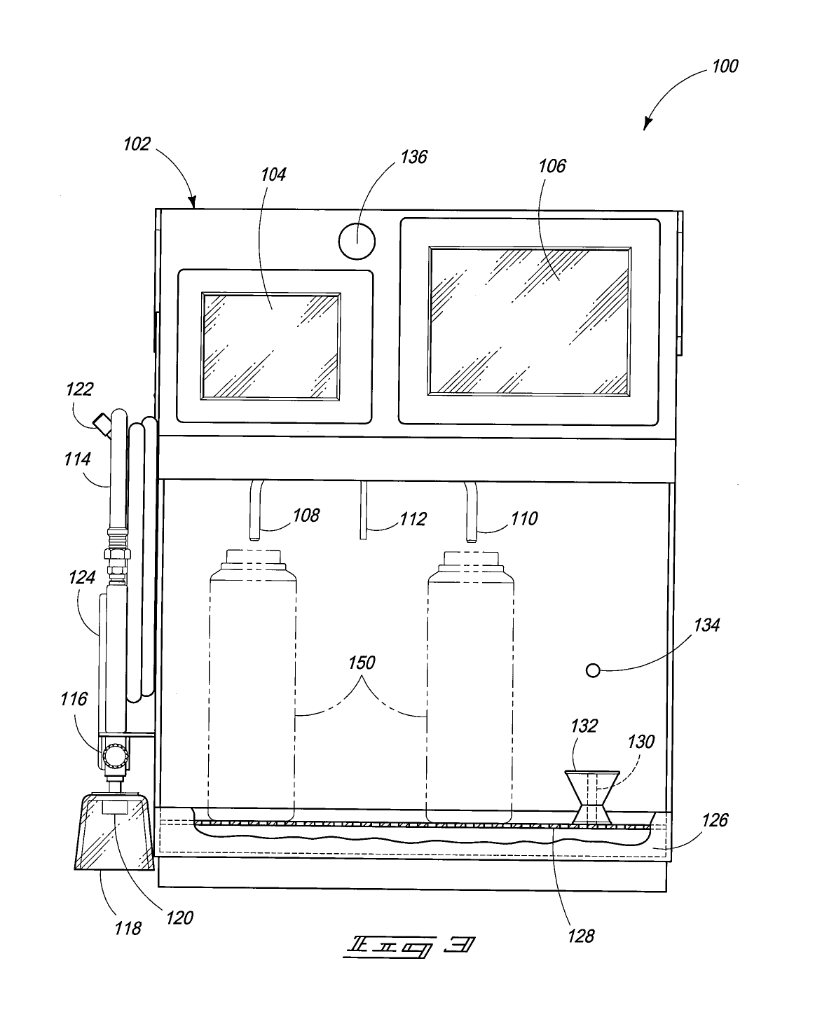

FIG. 3 shows 1 liter water bottles 150 represented with phantom lines and positioned for filling. Still, 0.5 liter water bottles (not shown) as well as other shapes and sizes, including 1 gallon bulk containers, could be positioned similarly for filling. Notably, dispensing unit 100 includes a water spout 120 configured to dispense treated water through a hose 114. The flexibility and length of hose 114 may be selected to allow an interface with a fill opening of a consumer container positioned on a ground surface below dispensing unit 100. In such manner, dispensing unit 100 may be conveniently positioned on a countertop, fill small personal-sized containers, and yet also fill bulk containers with, for example, 2 to 5 gallon capacity. A fill valve 116 may be actuated with a lever 124, dispensing treated water through water spout 120 into such a container. A splash guard 118 may minimize spillage and hose 114 may be coiled on a hook 122 between uses.

Water bottles 150 are shown resting on a perforated tray 128 in a drip pan 126 to collect spillage. A rinse spout 130 actuated by a button 136 is positioned in drip pan 126 for rinsing containers prior to filling. A splash guard 132 drains into drip pan 126 and a sensor 134 detects whether a container is present prior to allowing rinse actuation by button 136. Understandably, a container is held over rinse spout 130 within splash guard 132 in a rinsing position that is inverted with respect to the dispensing position of water bottles 150.

Sensor 134 as shown may be a known type of positional sensor, such as an ultrasonic sensor, that functions without the container contacting the sensor. Sensor 134 may instead be a known type of mechanical sensor with a contact switch, wherein the container touches a mechanism that opens or closes a contact. In dispensing unit 100, sensor 134 merely activates button 136 to allow rinsing when button 136 is depressed. Sensor 134 as shown does not connect to the process control system accessed via touch screen 104, though it may be. In such case, touch screen 104 may be used to actuate rinsing.

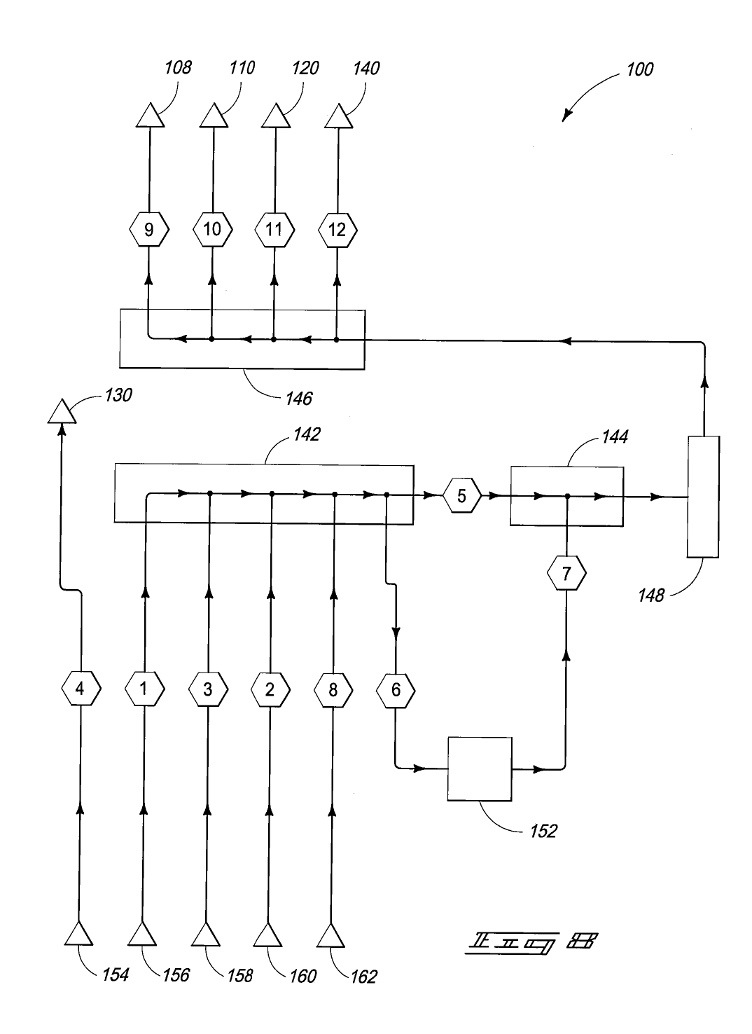

Ventilation holes 138 in housing 102 allow air circulation to reduce heat accumulation from internal components. The internal components of dispensing unit 100, while not shown in structural detail, are explained in the simplified process flow diagram of FIG. 8.

An acidic water supply line 154, RO water supply line 156, alkaline water supply line 158, filtered water supply line 160, and carbonated, filtered water supply line 162 are shown connected to solenoid-operated valves 4, 1, 3, 2, 8, respectively. Although solenoid-operated valves are described, other types of known, suitable control valves may be used. Valve 4 is in turn connected to rinse spout 130. Solenoid-operated valves 1, 3, 2, and 8 are connected to an inlet manifold 142, which receives the four types of treated water, but not the acidic water, for routing through subsequent processing. Supply lines may be color coded for easy identification.

For example, using solenoid-operated valves 5, 6, and 7, in various opened and closed combinations allows the four types of treated water to be routed to an ultraviolet sterilizer 148 via a chill manifold 144, whether first chilled individually in a cold tank 152 or not. A known device of suitable capacity and design for the purposes described herein may be used for ultraviolet sterilizer 148. After being sterilized, the four types of treated water enter an outlet manifold 146 and are dispensed through water spouts 108, 110, and/or 120, depending on which of respective solenoid-operated valves 9, 10, and 11 are open.

In the circumstance wherein one type of treated water was chilled in cold tank 152 and a subsequent desire exists to chill a different type of treated water, cold tank 152 may be purged through a purge spout 140 to a drain (not shown). A known device of suitable capacity and designed for the purposes described herein may be used for cold tank 152. For example, devices used in drinking water fountains may be suitable.

The Table below shows which valves may be opened to dispense the listed type of treated water through water spout 108 or purge spout 140. A listed type of treated water may instead or additionally be dispensed through water spouts 110 and/or 120 by opening respective valves 10 and/or 11. In the event that treated water is to be dispensed through water spout 120 (i.e., to a bulk container), one control scheme would prevent chilling in cold tank 152 if its capacity would be insufficient. The particular embodiment shown in FIGS. 1-3 has a small footprint and is configured primarily for personal-sized containers. Consequently, while other dispensing units may allow chilling of water for bulk containers, the embodiment shown in FIGS. 1-3 likely would not.

| | TABLE | | | | | | | | | | | |
|---|---|---|---|---|---|---|---|---|---|---|---|---|
| | Valve | | | | | | | | | | | |
| Water Type | 1 | 2 | 3 | 4 | 5 | 6 | 7 | 8 | 9 | 10 | 11 | 12 |
| Room Temp. | | | | | | | | | | | | |
| RO | ◯ | | | | ◯ | | | | ◯ | | | |
| Alkaline | | | ◯ | | ◯ | | | | ◯ | | | |
| Filtered | | ◯ | | | ◯ | | | | ◯ | | | |
| Carb. Filtered | | | | | ◯ | | | ◯ | ◯ | | | |
| Acidic | | | | ◯ | | | | | | | | |
| Chilled | | | | | | | | | | | | |
| RO | ◯ | | | | | ◯ | ◯ | | ◯ | | | |
| Alkaline | | | ◯ | | | ◯ | ◯ | | ◯ | | | |
| Filtered | | ◯ | | | | ◯ | ◯ | | ◯ | | | |
| Carb. Filtered | | | | | | ◯ | ◯ | ◯ | ◯ | | | |
| Maintenance | | | | | | | | | | | | |
| Purge | | | | | | | ◯ | | | | | ◯ |

One advantage of the process design in FIG. 8 includes scaling. If more or fewer types of treated water are desired, then an inlet manifold 142 may be provided with more or fewer inputs and another solenoid-operated valve added. Similarly, if more or fewer spouts are desired, then a different outlet manifold 146 may be provided. Such an arrangement allows simple retrofitting to adjust to consumer demand without replacing dispensing unit 100. Using a PLC allows the process control to be reprogrammed with the retrofitted arrangement. The process design of FIG. 8 also allows placement of connections between manifolds, valves, supply lines, and other liquid-containing devices at a lower level with much of the electrical wiring and electronics at an upper level within dispensing unit 100. Leaks, if any, are thus less likely to cause short circuiting or other electrical hazards since they would drain away from apparatuses carrying electric current.

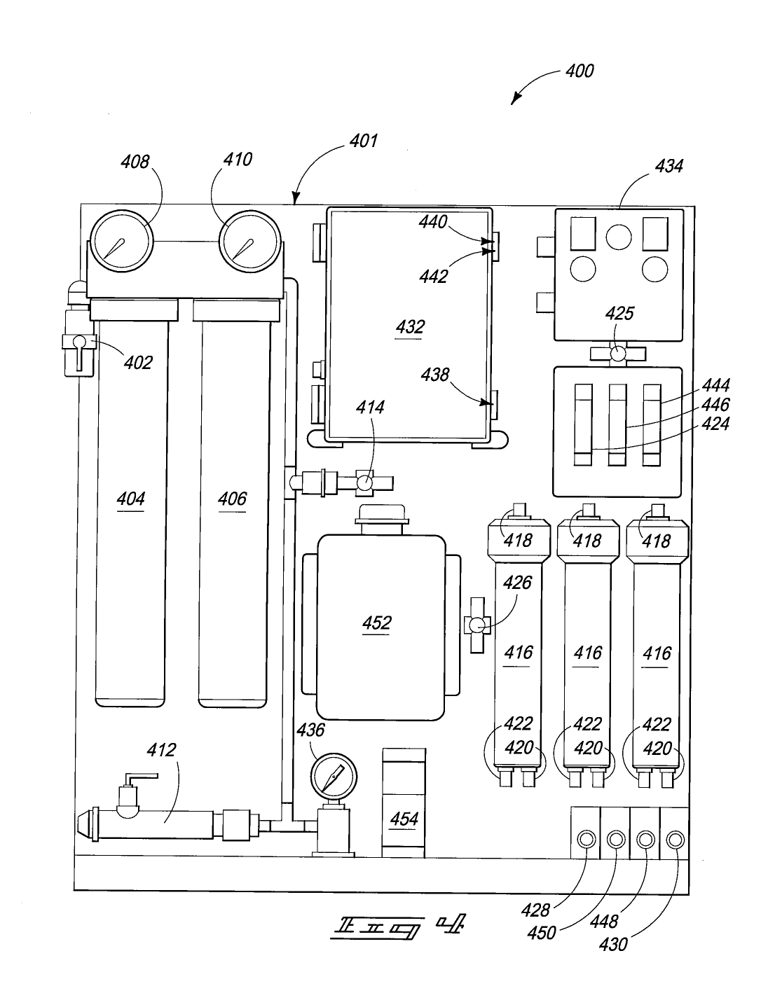

FIGS. 4-6 show respective front views of a filtration skid 400, a tank skid 500, and one example of a treatment unit 700 that includes filtration skid 400 mounted on tank skid 500. In alternative embodiments, filtration skid 400 may be separately mounted to a wall or other structure while tank skid 500 rests on wheels or the floor nearby or in a remote location with respect to filtration skid 400, depending on space or other constraints.

A skid frame 401 provides a mounting surface for the various treatment devices and other apparatuses of filtration skid 400. A main water inlet valve 402 receives and may isolate a water supply, such as domestic water. A pre-filter 404 may remove sediment and other foreign material upstream of a carbon filter 406 containing activated carbon. Depending on composition of the water supply, specifications for components of treatment unit 700, and/or desired quality of the filtered water, carbonated filtered water, and alkaline water, a known at most 5 micron pre-filter may be used. For example, an at most 1 micron pre-filter may be used. Filtration through activated carbon primarily removes organic contaminants and improves water palatability. A filter inlet pressure gauge 408 and a filter outlet pressure gauge 410 monitor pre-filter 404 and carbon filter 406 for clogging. A filtered water outlet valve 412 supplies filtered water to filtered water supply line 160 and tank skid 500 for a carbonator 526, discussed below.

A RO inlet valve 414 receives filtered water from carbon filter 406 for a panel of RO membrane housings 416 supplied through RO membrane inlets 418. RO water (or reverse osmosis “permeate”) exits housings 416 through RO membrane water outlets 420. Brine (or reverse osmosis “concentrate”) exits housings 416 through RO membrane brine outlets 422. If multiple RO membranes are used, as shown, the RO membranes may be in parallel connection, series connection, or a combination of parallel and series. In the shown configuration, two of RO membrane housings 416 are connected in parallel as a first stage with the output of the two being combined for input to the third RO membrane housing 416 as a second stage. Known configurations may be used instead.

A RO water outlet valve 425 may isolate and control the flow of RO water to a RO water manifold port 428 leading to a RO tank 504 on tank skid 500. A RO brine outlet valve 426 may isolate and control the flow of brine to a RO brine manifold port 430 leading to a drain (not shown). Depending on the volume of water processed in RO membrane housings 416, it might be advantageous to provide a flow meter (not shown) to indicate the volume of brine wasted. With such an indication, process optimization might improve economics by reducing brine volume.

Filtration skid 400 also includes an alkalinizer, specifically, an electrolytic cell 432. A power panel 434 provides electric current to electrolytic cell 432 to accomplish electrolysis. A cell inlet pressure regulator 436 receives filtered water from carbon filter 406 and supplies a cell inlet 438. A cell inlet flow meter 424 indicates flow rate.

Electrolytic cell 432 may be configured to produce both alkaline and acidic water, or to produce only alkaline water using known techniques and apparatuses. One example of an electrolytic cell includes an ECO 120 water ionizer available from Envirolyte Industries International Ltd. in Estonia. As is known, the ECO 120 may be configured to produce only alkaline water or both alkaline and acidic water. FIG. 4 shows electrolytic cell 432 with both a cell alkaline outlet 440 and a cell acidic outlet 442.

An alkaline flow meter 446 indicates the flow rate of alkaline water to an alkaline manifold port 450 leading to an alkaline tank 506 on tank skid 500. Similarly, an acidic flow meter 444 indicates the flow rate of acidic water to an acidic manifold port 448 leading to an acidic tank 508 on tank skid 500.

Filtration skid 400 may include a cell descaling solution tank 452 and a cell descaling pump that may be used for maintenance purposes to cycle descaling solution through electrolytic cell 432 and preserve its performance.

Tank skid 500 includes a skid frame 502 providing a mounting surface for the various tanks and other apparatuses. Skid frame 502 may be suitably designed for mounting filtration skid 400 thereon, as mentioned above. The flow of RO water and alkaline water received respectively from RO water manifold port 428 and alkaline manifold port 450 may be controlled respectively by a RO level controller 510 and an alkaline level controller 512 mounted on RO tank 504 and alkaline tank 506, respectively. Known level controllers configured to start and stop liquid flow depending on tank level may be used.

If a desire exists to deactivate a component of treatment unit 700 when RO tank 504 and/or alkaline tank 506 are not being filled, then RO level controller 510 and/or alkaline level controller 512 may be configured to actuate such a deactivation. For example, alkaline level controller 512 may signal electric power shut off to electrolytic cell 432 and close a solenoid-operated or other type of valve (not shown) to stop flow to cell inlet 438. Turning off power and stopping inlet flow may avoid a low flow condition in electrolytic cell 432 that might damage the cell.

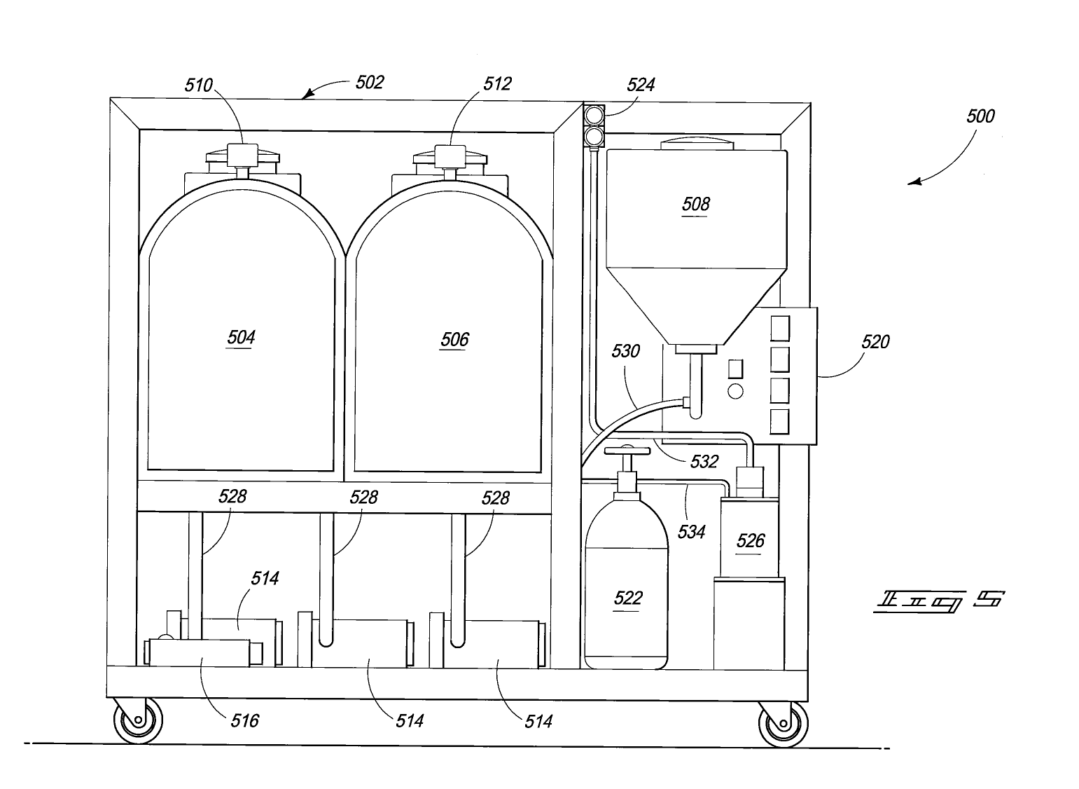

When signaled by dispensing unit 100, one of three pumps 514 withdraws RO water from RO tank 504 and discharges it through a respective discharge line 528 to RO water supply line 156. A tank empty sensor (not shown) interfaced with sensor connector 516 shuts off pump 514 before running dry. In like manner, the other two of pumps 514 withdraw alkaline water and acidic water from respective alkaline tank 506 and acidic tank 508 and discharge it through respective discharge lines 528 to alkaline water supply line 158 and acidic water supply line 154. Corresponding tank empty sensors in alkaline tank 506 and acidic tank 508 are interfaced with sensor connector 516 to shut off pumps 514 when appropriate. A drain line 530 of acidic tank 508 shown in FIG. 5 feeds the respective pump 514. Respective drain lines for RO tank 504 and alkaline tank 506 are not shown. A power panel 520 supplies power to the various pumps and controls of tank skid 500.

Tank skid 500 also includes carbonator 526 that receives carbon dioxide gas via a gas feed line 532 from a carbon dioxide regulator 524 in turn supplied by a carbon dioxide tank 522. A water feed line 534 supplies filtered water to carbonator 526 to produce carbonated (sparkling), filtered water in turn supplied to carbonated, filtered water supply line 162. Although not shown in the Figures, it is conceivable that the RO water and/or alkalinized water or a split stream thereof could be carbonated in a similar arrangement or in some known manner. Adding carbonation for dispensing soft drinks is a well known practice with a variety of alternatives and may be adapted to the embodiments encompassed by the present document.

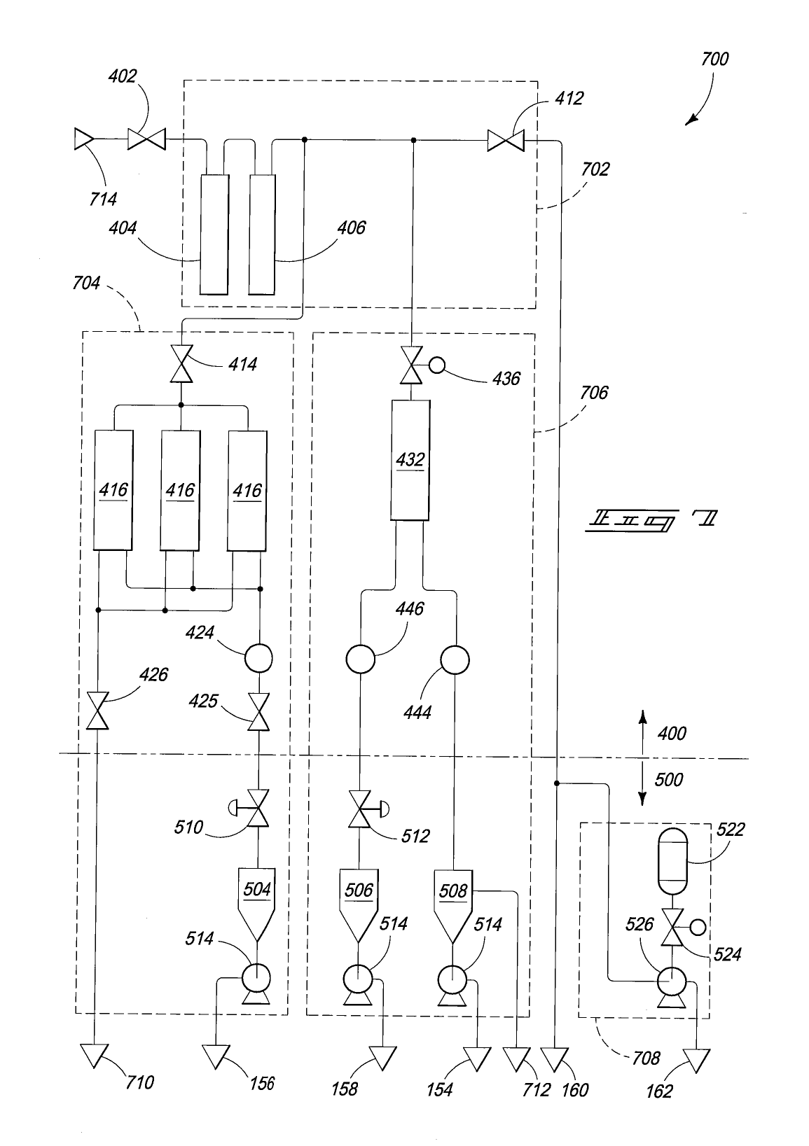

For simplicity, FIGS. 4-6 do not show all of the fluidic and electrical interconnections between the described devices. However, FIG. 7 shows a simplified process flow diagram for treatment unit 700 supporting the discussion above. FIG. 7 only shows the components believed useful in demonstrating the process flow through treatment unit 700.

Location of components in the process flow diagram on filtration skid 400 or tank skid 500 is differentiated by the horizontal dashed line across FIG. 7. Additionally, components in treatment unit 700 may be grouped into a filtration subunit 702, a RO subunit 704, an alkalinization subunit 706, and a carbonation subunit 708 as shown by dashed-line boxes. Although FIG. 7 shows carbonation subunit 708 fully comprised by tank skid 500, it is also conceivable that carbonation subunit 708 might be positioned elsewhere. Common practices for locating carbonation units in the dispensing of soft drinks may be instructive of possible options.

FIG. 7 additionally shows a brine dump line 710 from RO brine outlet valve 426 to a drain (not shown). Dump line 710 connects to RO brine manifold port 430 (not shown in FIG. 7). Notably, acidic tank 508 does not include a level controller like RO tank 504 and alkaline tank 506. Instead, acidic overflow line 712 routes excess acidic water to a drain (not shown). FIG. 7 further shows a water supply line 714 connected to main water inlet valve 402.

One advantage of the process flow design shown in FIG. 7 includes the ability to size RO membrane 416 and electrolytic cell 432 smaller than might be used directly to meet demand at dispensing unit 100. Instead, water demand may be met by RO tank 504, alkaline tank 506, and acidic tank 508. RO level controller 510 and alkaline level controller 512 may be configured and the tanks may be sized to keep a sufficient volume of water available for dispensing. RO membrane 416 and electrolytic cell 432 may refill the tanks as needed, including during lapses in dispensing. Such a design allows a reduction in cost of treatment unit 700 compared to a system directly feeding water from RO membrane 416 and electrolytic cell 432 to dispensing unit 100. Less significant cost advantages exist for including accumulation tanks in filtration subunit 702 and carbonation subunit 708 given greater throughput of carbon filter 406 and carbonator 526 compared to RO membrane 416 and electrolytic cell 432.

The discussion above allows many possible alternatives in a water dispensing system. In one embodiment, a water dispensing system includes a dispensing unit and a treatment unit. The treatment unit is remotely located and structurally independent from the dispensing unit. The treatment unit includes at least two of the following three subunits capable of producing at least two types of treated water: 1) a reverse osmosis subunit capable of producing and accumulating RO water, 2) an alkalinization subunit capable of producing and accumulating alkaline water, and 3) a carbon filtration subunit capable of producing filtered water. At least two treated water supply lines respectively connect the at least two subunits of the treatment unit to the dispensing unit. A wired and/or a wireless process control unit optionally includes process control wiring between the dispensing unit and the treatment unit. All physical connections between the dispensing unit and the treatment unit consist of the at least two treated water supply lines and the process control wiring, if any.

By way of example, the dispensing unit may include at least one common spout and an arrangement of at least one manifold and multiple control valves between the at least two treated water supply lines and the at least one common spout. The arrangement may be capable of being controlled to individually dispense the at least two types of treated water at different times from the at least one common spout into consumer containers without substantial commingling. The at least one common spout may include a flexible hose of sufficient length to be capable of interfacing with a fill opening of a consumer container positioned on a ground surface below the dispensing unit.

The treatment unit may include a filtration skid and a tank skid. The filtration skid includes a reverse osmosis filter of the reverse osmosis subunit, an alkalinizer of the alkalinization subunit, and a carbon filter of the carbon filtration subunit. The tank skid is structurally independent from the filtration skid and includes an RO water accumulation tank of the reverse osmosis subunit fluidically connected to the reverse osmosis filter. The tank skid also includes an alkaline water accumulation tank of the alkalinization subunit fluidically connected to the alkalinizer. The at least two treated water supply lines are respectively connected to the reverse osmosis accumulation tank and the alkaline water accumulation tank.

The system may include the three subunits capable of producing at least three types of treated water and at least three treated water supply lines respectively connecting the at least three subunits of the treatment unit to the dispensing unit. All physical connections between the dispensing unit and the treatment unit consist of the at least three treated water supply lines and the process control wiring, if any. The treatment unit may further include a carbonation subunit capable of treating a portion of the filtered water as a fourth type of treated water. At least four treated water supply lines respectively connect the four subunits of the treatment unit to the dispensing unit. All physical connections between the dispensing unit and the treatment unit consist of the at least four treated water supply lines and the process control wiring, if any.

The alkalinization subunit may be an electrolysis subunit also capable of producing and accumulating acidic water as an additional type of treated water. The dispensing unit further includes a rinsing spout capable of spraying consumer containers with the acidic water.

The dispensing unit may include a common cold tank and an arrangement of at least one manifold and multiple control valves between the at least two treated water supply lines and the common cold tank. The arrangement is capable of being controlled to individually cool the least two types of treated water at different times in the common cold tank without substantial commingling. The process control unit may further include a memory device capable of keeping a record of the last type of treated water cooled in the common cold tank and may be capable of purging the common cold tank prior to cooling a different type of treated water.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

### TABLE OF REFERENCE NUMERALS FOR FIGS. 1-8

| | |
|---|---|
| 100 | dispensing unit |
| 102 | housing |
| 104 | touch screen |
| 106 | display screen |
| 108 | water spout |
| 110 | water spout |
| 112 | flavor spout |
| 114 | hose |
| 116 | fill valve |
| 118 | splash guard |
| 120 | water spout |
| 122 | hook |
| 124 | lever |
| 126 | drip pan |
| 128 | tray |
| 130 | rinse spout |
| 132 | splash guard |
| 134 | sensor |
| 136 | button |
| 138 | ventilation holes |
| 140 | purge spout |
| 142 | inlet manifold |
| 144 | chill manifold |
| 146 | outlet manifold |
| 148 | UV sterilizer |
| 150 | water bottle |
| 152 | cold tank |
| 154 | acidic water supply line |
| 156 | RO water supply line |
| 158 | alkaline water supply line |
| 160 | filtered water supply line |
| 162 | carb., filtered water supply line |
| 400 | filtration skid |
| 401 | skid frame |
| 402 | main water inlet valve |
| 404 | pre-filter |
| 406 | carbon filter |
| 408 | filter inlet pressure gauge |
| 410 | filter outlet pressure gauge |
| 412 | filtered water outlet valve |
| 414 | RO inlet valve |
| 416 | RO membrane |
| 418 | RO membrane inlet |
| 420 | RO membrane water outlet |
| 422 | RO membrane brine outlet |
| 424 | cell inlet flow meter |
| 425 | RO water outlet valve |
| 426 | RO brine outlet valve |
| 428 | RO water manifold port |
| 430 | RO brine manifold port |
| 432 | electrolytic cell |
| 434 | power panel |
| 436 | cell inlet pressure regulator |
| 438 | cell inlet |
| 440 | cell alkaline outlet |
| 442 | cell acidic outlet |
| 444 | acidic flow meter |
| 446 | alkaline flow meter |
| 448 | acidic manifold port |
| 450 | alkaline manifold port |
| 452 | cell descaling solution tank |
| 454 | cell descaling pump |
| 500 | tank skid |
| 502 | skid frame |
| 504 | RO tank |
| 506 | alkaline tank |
| 508 | acidic tank |
| 510 | RO level controller |
| 512 | alkaline level controller |
| 514 | pump |
| 516 | tank empty sensor connector |
| 520 | power panel |
| 522 | CO₂ tank |
| 524 | CO₂ regulator |
| 526 | carbonator |
| 528 | discharge line |
| 530 | drain line |
| 532 | gas feed line |
| 534 | water feed line |
| 700 | treatment unit |
| 702 | filtration subunit |
| 704 | RO subunit |
| 706 | alkalinization subunit |
| 708 | carbonation subunit |
| 710 | brine dump line |
| 712 | acidic overflow line |
| 714 | water supply line |

The invention claimed is:

1. A water dispensing method comprising:
performing at least two of the following three treatments to produce at least two types of treated water:
treating water by reverse osmosis to produce RO water;
treating water by alkalinization to produce alkaline water, which has a pH greater than 7; and
treating water by filtration through carbon to produce filtered water; and
without substantially commingling the at least two types of treated water, individually dispensing the at least two types of treated water at different times from at least one common spout into consumer containers.

2. The method of claim 1 comprising performing the three treatments to produce at least three types of treated water and, without substantially commingling the at least three types of treated water, individually dispensing the at least three types of treated water at different times from the at least one common spout into consumer containers.

3. The method of claim 2 further comprising treating a portion of the filtered water by carbonation to produce carbonated, filtered water as an additional type of treated water and, without substantially commingling the four types of treated water, individually dispensing the four types of treated water at different times from the at least one common spout into consumer containers.

4. The method of claim 1 wherein the at least one common spout is comprised by a dispensing unit and the at least two treatments occur in a treatment unit that is remotely located and structurally independent from the dispensing unit, the method further comprising supplying the at least two types of treated water from the treatment unit to the dispensing unit through at least two respective treated water supply lines.

5. The method of claim 4 further comprising communicating process control signals between the dispensing unit and the treatment unit, wherein all physical connections between the dispensing unit and the treatment unit during operation consist of the at least two treated water supply lines and the process control signals, along with their wired or wireless carrier media.

6. The method of claim 1 wherein the treatment by alkalinization comprises electrolysis that also produces acidic water, which has a pH less than 7, as an additional type of treated water, the method further comprising rinsing the consumer containers with the acidic water prior to the dispensing from the at least one common spout by using a rinsing spout separate from the at least one common spout.

7. The method of claim 1 further comprising, without substantially commingling the at least two types of treated water, individually cooling the at least two types of treated water at different times in a common cold tank prior to the dispensing from the at least one common spout.

8. The method of claim 7 further comprising keeping a record of the last type of treated water cooled in the common cold tank and purging the common cold tank prior to cooling a different type of treated water.

9. The method of claim 1 wherein the dispensing from the at least one common spout occurs as a part of retail transactions in response to purchasers' selections input to a programmable logic controller that controls the dispensing.

10. A water dispensing method comprising:
performing at least two of the following three treatments to produce at least two types of treated water:
treating water by reverse osmosis to produce RO water;
treating water by alkalinization to produce alkaline water, which has a pH greater than 7; and
treating water by filtration through carbon to produce filtered water;
without substantially commingling the at least two types of treated water, individually cooling the at least two types of treated water at different times in a common cold tank prior to dispensing the at least two types of treated water from at least one spout, the dispensing occurring as a part of a retail transaction in response to a purchaser's selections input to a programmable logic controller that controls the dispensing; and
the programmable logic controller keeping a record of the last type of treated water cooled in the common cold tank and purging the common cold tank prior to cooling a different type of treated water.

11. The method of claim 10 wherein the common cold tank is comprised by a dispensing unit and the at least two treatments occur in a treatment unit that is remotely located and structurally independent from the dispensing unit, the method further comprising supplying the at least two types of treated water from the treatment unit to the dispensing unit through at least two respective treated water supply lines.

12. The method of claim 11 further comprising communicating process control signals between the dispensing unit and the treatment unit, wherein all physical connections between the dispensing unit and the treatment unit during operation consist of the at least two treated water supply lines and the process control signals, along with their wired or wireless carrier media.

13. A water dispensing method comprising:
treating water by electrolysis to produce two types of treated water including alkaline water, which has a pH greater than 7, and acidic water, which has a pH less than 7;
performing at least one of the following two treatments to produce at least one additional type of treated water:
treating water by reverse osmosis to produce RO water; and
treating water by filtration through carbon to produce filtered water;
rinsing consumer containers with the acidic water from a rinsing spout; and
after the rinsing, individually dispensing the alkaline water and the at least one additional type of treated water from at least one spout separate from the rinsing spout into the rinsed consumer containers, the dispensing occurring as a part of retail transactions in response to purchasers' selections input to a programmable logic controller that controls the dispensing.

14. The method of claim 13 wherein the rinsing occurs with the consumer containers in a rinsing position that is inverted with respect to a dispensing position.

15. The method of claim 13 comprising:
performing the electrolysis and the two treatments to produce four types of treated water;
treating a portion of the filtered water by carbonation to produce carbonated, filtered water as fifth type of treated water;
individually dispensing the alkaline water, the RO water, the filtered water, and the carbonated, filtered water from the at least one spout, the rinsing spout and the at least one spout being comprised by a dispensing unit;
the four treatments occurring in a treatment unit that is remotely located and structurally independent from the dispensing unit; and
supplying the five types of treated water from the treatment unit to the dispensing unit through five respective treated water supply lines.

16. The method of claim 15 further comprising communicating process control signals between the dispensing unit and the treatment unit, wherein all physical connections between the dispensing unit and the treatment unit during operation consist of the five treated water supply lines and the process control signals, along with their wired or wireless carrier media.

17. A water dispensing system comprising:
a dispensing unit;
a treatment unit remotely located and structurally independent from the dispensing unit, the treatment unit including at least two of the following three subunits capable of producing at least two types of treated water:
a reverse osmosis subunit capable of producing and accumulating RO water;
an alkalinization subunit capable of producing and accumulating alkaline water, which has a pH greater than 7; and
a carbon filtration subunit capable of producing filtered water;
at least two treated water supply lines respectively connecting the at least two subunits of the treatment unit to the dispensing unit; and
a wired and/or wireless process control unit optionally including process control wiring between the dispensing unit and the treatment unit, all physical connections between the dispensing unit and the treatment unit consisting of the at least two treated water supply lines and the process control wiring, if any.

18. The system of claim 17 wherein the dispensing unit comprises:
at least one common spout; and
an arrangement of at least one manifold and multiple control valves between the at least two treated water supply lines and the at least one common spout capable of being controlled to individually dispense the at least two types of treated water at different times from the at least one common spout into consumer containers without substantially commingling the at least two types of treated water.

19. The system of claim 18 wherein the at least one common spout comprises a flexible hose of sufficient length to be capable of interfacing with a fill opening of a consumer container positioned on a ground surface below the dispensing unit.

20. The system of claim 17 wherein the treatment unit comprises:
a filtration skid including a reverse osmosis filter of the reverse osmosis subunit, an alkalinizer of the alkalinization subunit, and a carbon filter of the carbon filtration subunit; and
a tank skid structurally independent from the filtration skid and including an RO water accumulation tank of the reverse osmosis subunit fluidically connected to the reverse osmosis filter and an alkaline water accumulation tank of the alkalinization subunit fluidically connected to the alkalinizer, the at least two treated water supply lines being respectively connected to the RO water accumulation tank and the alkaline water accumulation tank.

21. The system of claim 17 comprising the three subunits capable of producing at least three types of treated water and at least three treated water supply lines respectively connecting the at least three subunits of the treatment unit to the dispensing unit, all physical connections between the dispensing unit and the treatment unit consisting of the at least three treated water supply lines and the process control wiring, if any.

22. The system of claim 21 wherein the treatment unit further comprises a carbonation subunit capable of treating a portion of the filtered water to produce carbonated, filtered water as a fourth type of treated water and at least four treated water supply lines respectively connecting the four subunits of the treatment unit to the dispensing unit, all physical connections between the dispensing unit and the treatment unit consisting of the at least four treated water supply lines and the process control wiring, if any.

23. The system of claim 17 wherein the alkalinization subunit is an electrolysis subunit also capable of producing and accumulating acidic water, which has a pH greater than 7, as an additional type of treated water, the dispensing unit further comprising a rinsing spout capable of spraying consumer containers with the acidic water.

24. The system of claim 17 wherein the dispensing unit comprises:
a common cold tank; and
an arrangement of at least one manifold and multiple control valves between the at least two treated water supply lines and the common cold tank capable of being controlled to individually cool the at least two types of treated water at different times in the common cold tank without substantially commingling the at least two types of treated water.

25. The system of claim 24 wherein the process control unit comprises a memory device capable of keeping a record of the last type of treated water cooled in the common cold tank and is capable of purging the common cold tank prior to cooling a different type of treated water.
